(19) United States
(12) Patent Application Publication
(10) Pub. No.: US 2025/0390560 A1
(43) Pub. Date: Dec. 25, 2025

(54) LICENSE MANAGEMENT SYSTEM, LICENSE MANAGEMENT METHOD, AND RECORDING MEDIUM

(71) Applicant: Mitsubishi Electric Corporation, Tokyo (JP)

(72) Inventors: Hideaki TASHIRO, Tokyo (JP); Hidematsu HAYASHI, Tokyo (JP); Tetsuhiro SODETA, Tokyo (JP)

(73) Assignee: Mitsubishi Electric Corporation, Tokyo (JP)

(21) Appl. No.: 18/878,968

(22) PCT Filed: Nov. 29, 2022
(86) PCT No.: PCT/JP2022/043933

§ 371 Date: Dec. 26, 2024

(51) Int. Cl. G06F 21/10

(52) U.S. Cl. CPC G06F 21/107

(57) ABSTRACT

A license management system includes an acquirer that acquires an application, an executor that executes the application, a providing section that provides, through a network, a feature implemented by execution of the application to a license acquiring object that has acquired a license, and a manager that manages, in a manner associated with application software being a target for the license, a new license acquiring object generated upon granting of the license from the license acquiring object with a range equivalent to a license range of the feature for which the license acquiring object has acquired the license or within the license range.

### TECHNICAL FIELD

The present disclosure relates to a license management system, a license management method, and a program.

### BACKGROUND ART

A cloud computing technique for providing a cloud service through a network by executing application software on a cloud server has recently received attention. This type of application software is provided by a provider such as a system integration (SI) company. The provider typically provides the cloud service to subscribers who are each under contract. To efficiently provide such a cloud service, techniques have been developed for managing information about the use contract of the cloud service (see, for example, Patent Literature 1).

### CITATION LIST

### Patent Literature

Patent Literature 1: Unexamined Japanese Patent Application Publication No. 2021-002128

### SUMMARY OF INVENTION

### Technical Problem

In the field of factory automation (FA), services are requested to be usable across series of connections such as engineering chains. When, for example, a trouble occurs on the production line of the end user, the end user notifies the line builder that has built the production line of the trouble. The line builder then identifies the device causing the trouble on the production line. In such a case, the end user, the line builder, and the device manufacturer may share information about the trouble using an operation maintenance service for general devices to reduce downtime.

To apply the technique in Patent Literature 1 to the contract for using the cloud service at such FA sites, each user of the cloud service is to directly conclude a use contract with the provider of application software. The use contract may be concluded based on the connections described above. For example, the above end user may conclude the use contract with the provider of the application software based on, for example, a maintenance period set with the line builder and a maintenance period set between the line builder and the manufacturer of the device.

However, properly determining the details of a use contract based on various circumstances is difficult. This increases the workload for using the cloud service at FA sites, possibly obstructing the use of the cloud service.

Under such circumstances, an objective of the present disclosure is to promote the use of the cloud service by reducing the workload for using the cloud service at FA sites.

### Solution to Problem

To achieve the above objective, a license management system according to an aspect of the present disclosure includes acquiring means for acquiring application software, execution means for executing the application software, providing means for providing, through a network, a feature implemented by execution of the application software to a license acquiring object that has acquired a license, and management means for managing, in a manner associated with the application software being a target for the license, a new license acquiring object generated upon granting of the license from the license acquiring object with a range equivalent to a license range of the feature for which the license acquiring object has acquired the license or within the license range.

### Advantageous Effects Of Invention

In the structure according to the above aspect of the present disclosure, the managing means manages the new license acquiring object generated upon granting of the license from the license acquiring object with the range equivalent to the license range of the feature for which the license acquiring object has acquired the license or within the license range. The managing means manages the new license acquiring object in a manner associated with the application software being a target for the license. Thus, the feature of the application software can be provided based on a sublicense concluded between objects. This facilitates the use of the cloud service based on a license reflecting the connections at FA sites, promoting the use of the cloud service by reducing the workload for using the cloud service at the FA sites.

### BRIEF DESCRIPTION OF DRAWINGS

FIG. 1 is a schematic diagram illustrating granting of a license and providing features of application software managed by a license management system according to Embodiment 1;

FIG. 2 is a diagram illustrating connections among the license management system, an application provider, and objects in Embodiment 1;

FIG. 3 is a diagram of example objects in Embodiment 1;

FIG. 4 is a block diagram of the license management system according to Embodiment 1, illustrating the hardware configuration;

FIG. 5 is a functional block diagram of the license management system according to Embodiment 1;

FIG. 6 is a diagram of a license management database (DB) in Embodiment 1;

FIG. 7 is a schematic diagram illustrating collection of object data in Embodiment 1;

FIG. 8 is a flowchart of an application feature providing process in Embodiment 1;

FIG. 9 is a flowchart of a license management process in Embodiment 1;

FIG. 10 is a diagram illustrating example changes in data in the license management DB in Embodiment 1;

FIG. 11 is a diagram illustrating a temporary database in a modification;

FIG. 12 is a diagram of an example license management DB in Embodiment 2; and

FIG. 13 is a diagram of a tree structure of granting a license in Embodiment 2.

### DESCRIPTION OF EMBODIMENTS

A license management system according to one or more embodiments of the present disclosure is described below in detail with reference to the drawings. The license management system manages a license for providing, through a network, features of application software executed on a cloud server. Hereafter, application software is simply referred to as an application as appropriate.

A party that is provided with the features of an application is hereafter referred to as an object. The object is not limited to an individual user, but may be a terminal, a device, or equipment, or may be a specific group of companies. The object is a generic term for a user or equipment that has acquired or has been provided with a license under a license contract. The object corresponds to each license. One object may be provided with two or more licenses.

Providing the features of an application refers to providing a cloud service and providing information or data resulting from execution of the application. The application execution result may be acquired by processing information that is input by the object on the cloud server, or may be information or data that is output by the cloud server independently of any input by the object.

### Embodiment 1

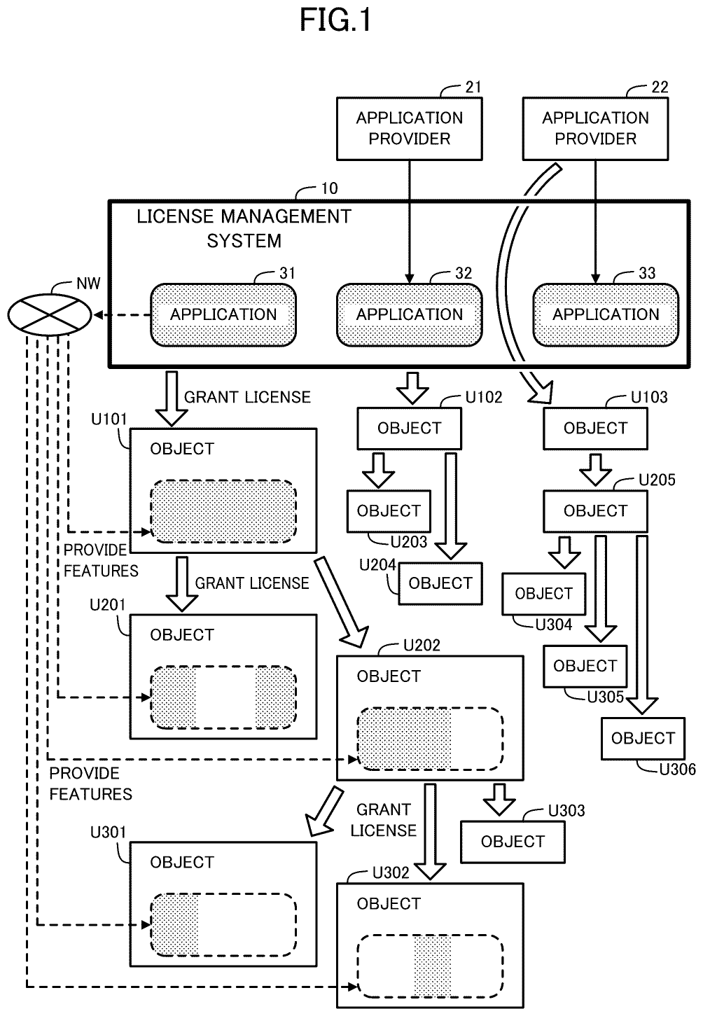

As illustrated in FIG. 1, a license management system 10 according to the present embodiment includes multiple applications and provides, through a network NW indicated by dashed arrows, the features of each application to a corresponding object that has acquired a license. More specifically, the license management system 10 includes an application 31 prestored in the license management system 10, an application 32 acquired from an application provider 21, and an application 33 acquired from an application provider 22.

Each of the application providers 21 and 22 is a system integration (SI) company or an application developer. Each of the application provider 21 and 22 may be hereafter referred to as an application provider 20 without distinction.

In FIG. 1, the outlined arrows indicate granting of licenses for using the features of the respective applications 31 to 33. More specifically, a license for using the application 31 is granted from the license management system 10 and acquired by an object U101. Granting a license from the license management system 10 may be granting a license from the operating entity of the license management system 10. The license for using the features of the application 31 is granted from the object U101 to objects U201 and U202, and from the object U202 to objects U301, U302, and U303. The objects U101, U201, U202, U301, and U302 are each permitted to use the features of the application 31 with the acquired license.

However, the range of available features for each object is set by the object granting the license. For example, in FIG. 1, the entirely hatched area surrounded by the broken line in the block corresponding to the object U101 indicates that all the features of the application 31 are available to the object U101. In other words, the hatched area indicates the range of available features. The object U101 grants a license for using a part of the features of the application 31 to each of the objects U201 and U202. The object U202 grants, within a range of available features for the object U202, a license for using a part of the features of the application 31 to each of the objects U301 and U302. An object that has acquired a license may grant, with a range of features equivalent to the range of the features for which the license is acquired by the object, the license to another object.

A license for using the features of the application 32 is granted from the license management system 10, acquired by an object U102, and then granted from the object U102 to objects U203 and U204. The objects U102, U203, and U204 are each permitted to use the features of the application 32 with the acquired license. A license for using the features of the application 33 is granted by the application provider 22, acquired by an object U103, granted from the object U103 to an object U205, and then granted from the object U205 to objects U304, U305, and U306. The objects U103, U205, U304, U305, and U306 are each permitted to use the features of the application 33 with the acquired license.

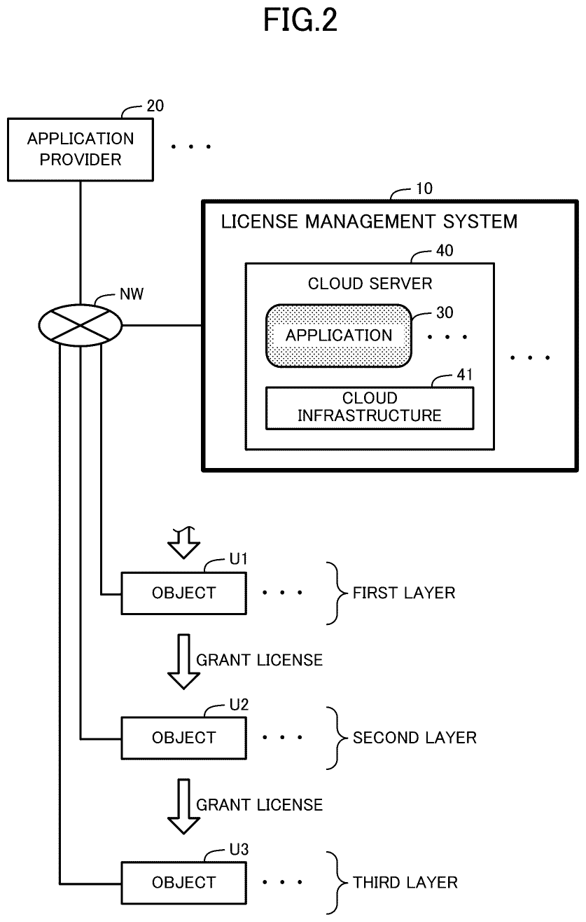

FIG. 2 schematically illustrates the device configuration of the license management system and connections of communication paths through the network NW. As illustrated in FIG. 2, the license management system 10 includes one or more cloud servers 40. Each cloud server 40 is a computer that is a server including a cloud infrastructure 41 being available and provided by a cloud manufacturer. The cloud server 40 executes one or more applications 30 on the cloud infrastructure 41. The application 30 refers to each of the application 31 to 33 without distinction. The cloud infrastructure 41 is a basic computational resource provided as a service such as an Infrastructure as a service (IaaS) or a Platform as a service (PaaS). When the license management system 10 is implemented by a single cloud server 40, the license management system 10 is substantially the same as the single cloud server 40. When the license management system 10 includes multiple cloud servers 40, the license management system 10 is implemented by the cloud servers 40 operating in cooperation.

The license management system 10, the application provider 20, and objects U1, U2, and U3 are connected through the network NW to communicate with one another. The network NW may be a wide area network such as the Internet, a virtual network such as a virtual private network (VPN), or a dedicated network.

The object U1 refers to any object of the objects U101, U102, and U103 illustrated in FIG. 1 without distinction, or to any object to which a license is granted from a grantor, such as the application provider 20 or the license management system 10, that is not to be provided with the application 30. In other words, the object U1 is a first object to which a license is directly granted to start the use of the application 30. The object U2 is an object to which the license is granted by the object U1, and corresponds to any of the objects U201 to U205 in FIG. 1. The object U3 is an object to which the license is granted by the object U2, and corresponds to any of the objects U301 to U306 in FIG. 1. With the object U1 in a first layer, the object U2 in a second layer, and the object U3 in a third layer, all the objects are each in one of the layers. Similarly, objects may be in fourth and subsequent layers. An object in an n-th layer grants a license to another object in an (n+1)th layer.

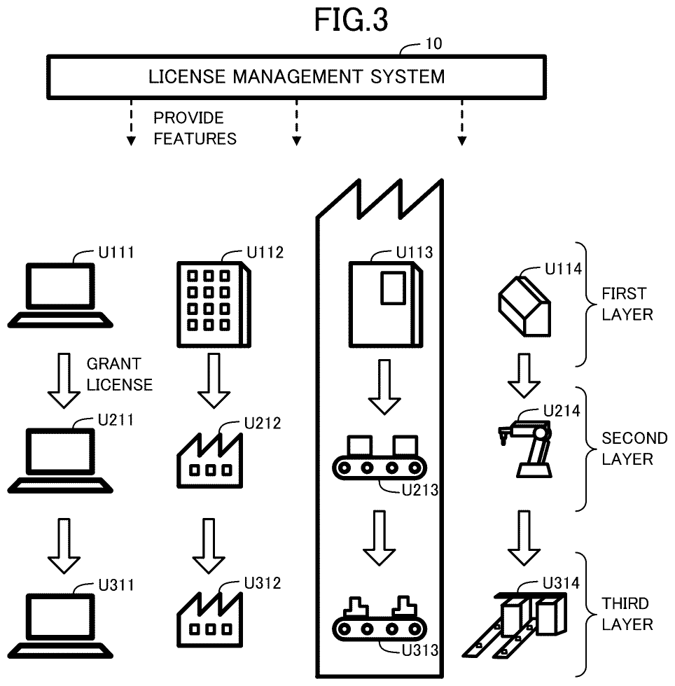

FIG. 3 illustrates example objects that are provided with features by the license management system 10. Objects U111, U211, and U311 in FIG. 3 correspond to personal computers (PCs) having a licensing relationship with one another. The objects U111, U211, and U311 may be three persons using a single PC. Objects U112, U212, and U312 correspond to separate companies having a licensing relationship with one another. Objects U113, U213, and U313 have a licensing relationship with one another. The object U113 corresponds to a host computer in a specific factory, the object U213 to a first line in the factory, and the object U313 to a second line in the factory. Objects U114, U214, and U314 have a licensing relationship with one another. The object U114 corresponds to a device of a specific manufacturer, the object U214 to a robot of another manufacturer including the device, and the object U314 to a production facility of an end user using the robot. In FIG. 3, the objects U111 to U114 are in the first layer, the objects U211 to U214 are in the second layer, and the objects U311 to U314 are in the third layer.

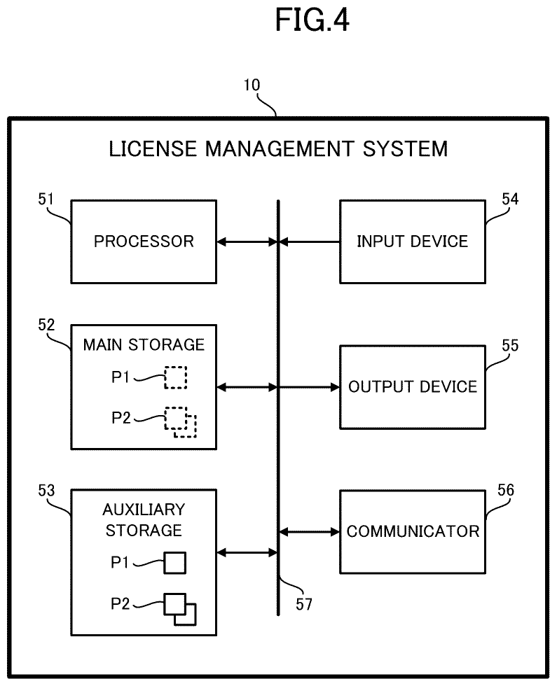

The license management system 10 has the hardware configuration illustrated in FIG. 4 to manage licenses granted to the objects described above. Although the license management system 10 with this hardware configuration corresponds to a single cloud server 40, the license management system 10 implemented by multiple cloud servers 40 substantially has the hardware configuration illustrated in FIG. 4, with more components cooperating with one another.

As illustrated in FIG. 4, the license management system 10 includes a processor 51, a main storage 52, an auxiliary storage 53, an input device 54, an output device 55, and a communicator 56. The main storage 52, the auxiliary storage 53, the input device 54, the output device 55, and the communicator 56 are each connected to the processor 51 with an internal bus 57.

The processor 51 includes a central processing unit (CPU) as a processing circuit. The processor 51 executes programs P1 and P2 stored in the auxiliary storage 53 to implement various functions to perform the processing described below.

The main storage 52 includes a random-access memory (RAM). The programs P1 and P2 are loaded into the main storage 52 from the auxiliary storage 53. The main storage 52 is used as a work area for the processor 51.

The auxiliary storage 53 includes a nonvolatile memory, such as an electrically erasable programmable read-only memory (EEPROM) and a hard disk drive (HDD). The auxiliary storage 53 stores the program P1 for implementing the functions (described below) of the license management system 10 and the program P2 corresponding to the application 30. The auxiliary storage 53 also stores various pieces of data used for processing performed by the processor 51. The auxiliary storage 53 provides data to be used by the processor 51 to the processor 51 as instructed by the processor 51. The auxiliary storage 53 stores data provided by the processor 51.

The input device 54 is, for example, a hardware switch, an input key, a keyboard, or a pointing device. The input device 54 acquires information input by an administrator of the license management system 10 and notifies the processor 51 of the acquired information.

The output device 55 includes, for example, a display device such as a light-emitting diode (LED) or a liquid crystal display (LCD), and an acoustic device such as a buzzer or a speaker. The output device 55 indicates various items of information to the administrator as instructed by the processor 51.

The communicator 56 includes an interface circuit for communicating with external devices. The communicator 56 receives signals through the network NW and outputs data carried by these signals to the processor 51. The communicator 56 also transmits signals carrying data output from the processor 51 to the network NW.

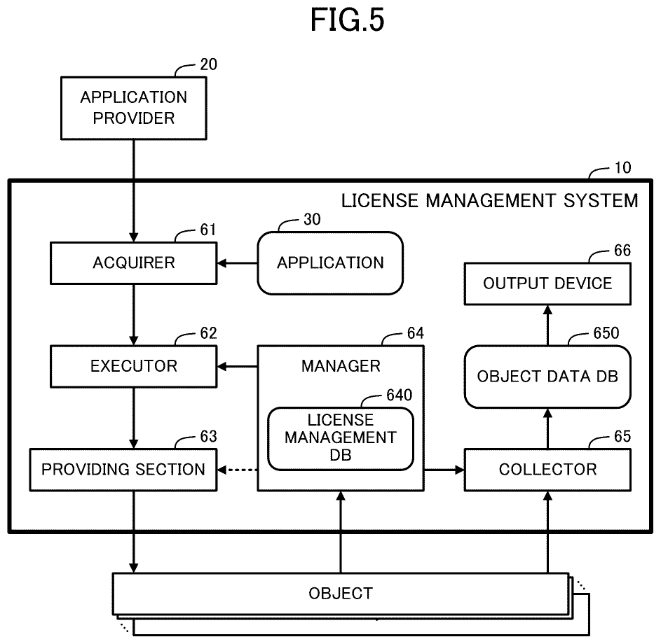

With the above hardware components cooperating with one another, the license management system 10 performs various functions. More specifically, as illustrated in FIG. 5, the license management system 10 includes, as functional components, an acquirer 61 that acquires the application 30, an executor 62 that executes the application 30, a providing section 63 that provides the features of the application 30 to objects, a manager 64 that manages licenses granted to the objects, a collector 65 that collects object data from the objects, an object data database (DB) 650 that accumulates the object data, and an output device 66 that outputs the object data.

The acquirer 61 is implemented by at least one of the processor 51, the input device 54, or the communicator 56. The acquirer 61 may acquire the application 30 by receiving the application 30 transmitted from the application provider 20, by reading the application 30 from a non-transitory recording medium, such as a memory card, or an external storage, or by reading the application 30 prestored in the auxiliary storage 53. The acquirer 61 may temporarily store the application 30 into the main storage 52 or the auxiliary storage 53. The acquirer 61 provides the acquired application 30 to the executor 62 when requested by the executor 62. The acquirer 61 corresponds to an example of acquiring means for acquiring application software.

The executor 62 is mainly implemented by the processor 51. The executor 62 executes the application 30 to generate information or data to be provided to an object. For example, the application 30 for updating driver software of a device monitors any update to the latest version of the driver, and distributes the latest version of the driver software when the software is updated. The application 30 for managing the quality of manufactured articles processes data transmitted from an object to monitor any abnormality, and notifies the object of the abnormality when an abnormality occurs. However, the executor 62 refers to a license management DB 640 to implement the features of the application 30 to be provided to an object with a license, and does not implement the features of the application 30 for an object with an invalid license. The executor 62 corresponds to an example of execution means for executing an application program.

The providing section 63 is mainly implemented by the processor 51 and the communicator 56 cooperating with each other. The providing section 63 provides the features implemented by execution of the application 30 to the object. The providing section 63 may refer to, instead of the executor 62, the license management DB 640 to provide the features of the application 30 to an object with a license, and exclude an object with an invalid license from the targets for providing the features of the application 30. The providing section 63 corresponds to an example of providing means for providing, through the network NW, the features of the application 30 to an object that has acquired a license. The providing means provides, to the object, the features with a range for which the license is acquired by the object.

The manager 64 is mainly implemented by the processor 51, the auxiliary storage 53, and the communicator 56 cooperating with one another. The manager 64 includes the license management DB 640 indicating the latest status of licenses granted to multiple objects. For any change associated with a license, the manager 64 writes data corresponding to the change into the license management DB 640 to update the license management DB 640.

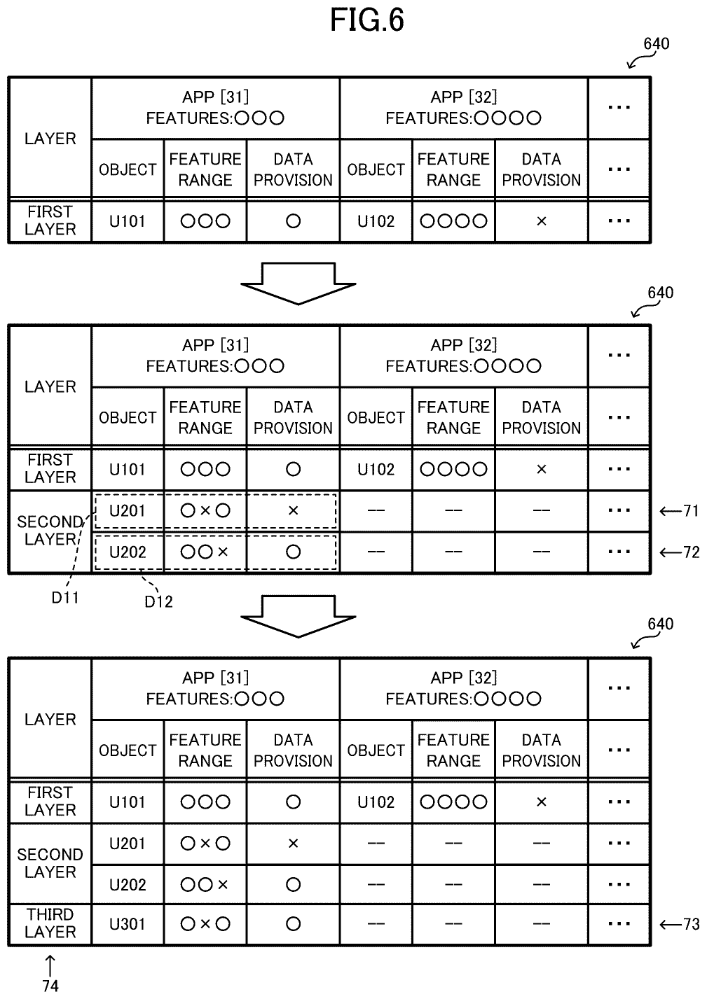

The upper part of FIG. 6 illustrates the license management DB 640 indicating the details of the licenses provided to the objects U101 and U102 in the first layer. The license management DB 640 includes an item of Object indicating an identification number that is the same as the reference sign of the object, an item of Feature range indicating the range of features of the application 30 set to be available to the object, and an item of Data provision indicating whether the object data about the use of the application 30 is permitted to be provided externally. These items are associated with the corresponding application 30. Each object is further associated with an item of Layer indicating the hierarchical layer of the object. In FIG. 6, each application 30 is identified with an identification number that is the same as the reference sign of the application 31 or 32. The consecutive circles as the features of the application 30 represent the number and the order of elements included in the features of the corresponding application 30. For example, the application 31 with the features indicated by three circles has a first partial feature, a second partial feature, and a third partial feature in this order.

The consecutive circles in the item of Feature range indicate that all the features of the application are available. The details in the item of Feature range are set by the license grantor. For example, the range of the features of the application 31 available to the object U101 is set to all of the features of the application 31 by the license management system 10.

The circle in the item of Data provision indicates that the object data is permitted to be provided externally. A cross in this item indicates that the object data is not permitted to be provided externally. The item of Data provision is set by the object to which the license is granted. For example, the circle in this item indicates that the object U101 permits the object data to be provided externally, whereas the cross indicates that the object U102 does not permit the object data to be provided externally. The object data is provided based on the feature range available with the license and used together with the features of the application 30. The Feature range and the Data provision are thus dependent on each other.

The object data is at least one of data for using the features of the application 30 such as a setting parameter and data input into the application 30 or data generated by use of the application 30 such as an execution result of the application 30 and a response of the object to the execution. The object data about an object that is a sensor may be sensing results from use of the application 30 as driver software. Externally providing the object data may be providing the sensing results periodically. The license management system 10 collects the object data.

The middle part of FIG. 6 illustrates the license management DB 640 storing data D11 and data D12 about a license granted from the object U101 to the objects U201 and U202. More specifically, the object U101 sets the feature range of the application 31 available to the object U201 excluding the second partial feature, with the object U201 not permitting the object data to be provided externally. The data D11 is added in this manner. The object U101 sets the feature range of the application 31 available to the object U202 excluding the third partial feature, with the object U202 permitting the object data to be provided externally. The data D12 is added in this manner. The data D11 and the data D12 are added as data in the second layer including row data 71 and row data 72.

Such setting for license granting is performed by the license granting object accessing the license management system 10 and inputting information indicating the object that is a granting target and the feature range of the license to be granted, and by the license acquiring object accessing the license management system 10 and inputting information indicating whether the license acquiring object permits the object data to be provided externally. The manager 64 generates data of an input format for receiving input from the objects, and outputs the input format through the network NW to receive the settings for license granting between objects.

The license granting object is an object that grants a license or an object to grant a license. The license acquiring object is an object that acquires a license or an object that has acquired a license. Although all the objects registered with the license management DB 640 each correspond to the license acquiring object, the object may be hereafter referred to as the license acquiring object to emphasize that the object has acquired the license or is to acquire the license. Similarly, the object may be referred to as the license granting object to emphasize that object has granted a license.

The lower part of FIG. 6 illustrates the license management DB 640 to which the details of the license granted to the object U301 are added as row data 73. As illustrated in the lower part of FIG. 6, the objects are classified into hierarchical layers defined in a column 74. The license management DB 640 thus hierarchically manages the license acquiring objects that have acquired a license.

The manager 64 corresponds to an example of managing means for managing, in a manner associated with the application software being a target for the license, a new license acquiring object generated upon granting of the license from the license acquiring object with a range equivalent to a license range of the feature for which the license acquiring object has acquired the license or within the license range.

Referring back to FIG. 5, the collector 65 is mainly implemented by the processor 51 and the communicator 56 cooperating with each other. The collector 65 collects, with reference to the license management DB 640, object data from the objects permitting the object data to be provided externally in the license management DB 640. The collector 65 accumulates the collected object data into the object data DB 650. The collector 65 corresponds to an example of collection means for collecting object data.

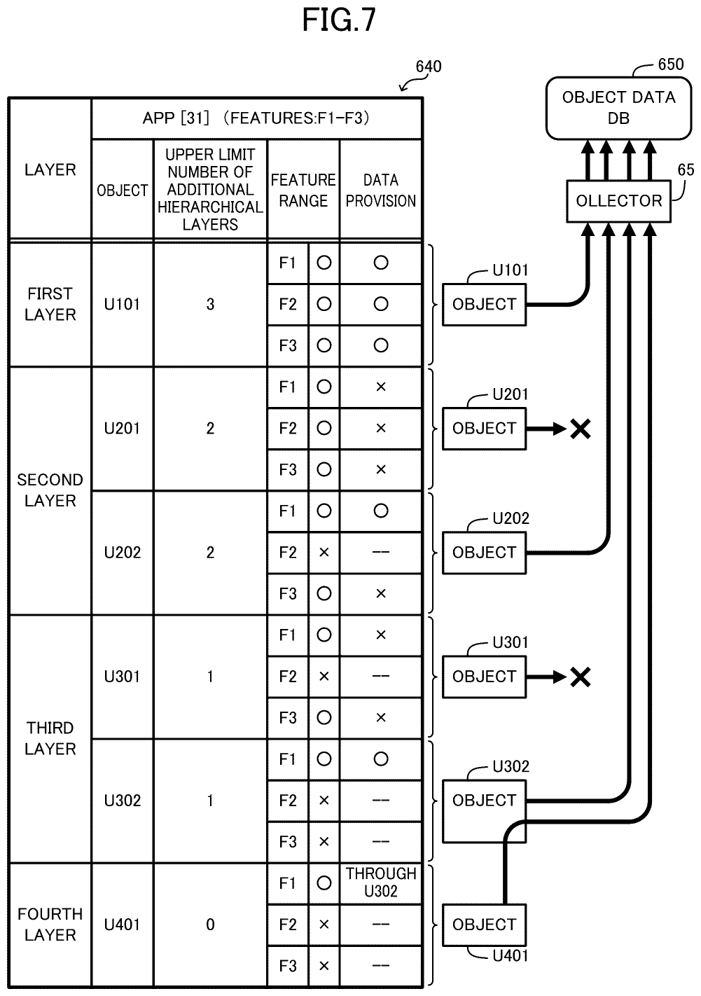

FIG. 7 schematically illustrates an example license management DB 640 different from the license management DB 640 in FIG. 6, and schematically illustrates collection of object data based on this license management DB 640. The license management DB 640 in FIG. 7 indicates that the application 31 has partial features F1 to F3 and indicates whether the object data is permitted to be provided externally for each of the partial features F1 to F3. For example, the object U202 permits the object data associated with the feature F1 to be provided externally and does not permit the object data associated with the feature F3 to be provided externally. For the object U202, the feature F2 is excluded from the available range. Thus, the setting as to whether the object data associated with the feature F2 is permitted to be provided externally is unset. In this manner, the setting as to whether data is provided may be performed for each partial feature.

For an object U401 in the fourth layer, the object data associated with the feature F1 is permitted to be provided externally, with the object data being set to be externally provided through the object U302. In FIG. 7, the thick arrows indicate the paths of the object data being collected by the collector 65. More specifically, the collector 65 collects, with reference to the license management DB 640, object data from the objects U101, U202, and U302, and does not collect object data from the objects U201 and U301.

The collector 65 also collects object data about the object U401 from the object U302. When the object U401 corresponds to an embedded device, with the object U302 including a device that functions as the object U401, the object U401 cannot easily provide the object data directly to the collector 65. The object data is thus easily collected through the object U302.

In the license management DB 640 in FIG. 7, each object is further associated with an upper limit number of additional hierarchical layers. The upper limit number of additional hierarchical layers indicates an upper limit number of hierarchical layers permitted to be newly added or the remaining number of generations to which the license is permitted to be granted, indicating an upper limit number of times the object that has acquired a license is permitted to grant the license repeatedly. For example, as illustrated in FIG. 7, when a license with the upper limit number of additional hierarchical layers of 3 is granted to the object U101, the upper limit number of additional hierarchical layers of the license to be granted from the object U101 to the objects U201 and U202 is decremented to 2. For every repeated granting of the license between objects starting from the object U101, the upper limit number of additional hierarchical layers is decremented. Thus, although the license is granted between the objects up to the fourth layer, the object in the fourth layer cannot grant the license to another object. Thus, the fifth layer is not formed.

Referring back to FIG. 5, the output device 66 is mainly implemented by at least one of the processor 51 or the communicator 56. The output device 66 reads data from the object data DB 650, and outputs the data to the application provider 20 that provides the application 30 corresponding to the object data. This allows the application provider 20 to analyze the object data about multiple objects using the application 30. For example, the application provider 20 can use the data to determine the amount of carbon dioxide emissions in the entire supply chain associated with production and to achieve carbon neutrality.

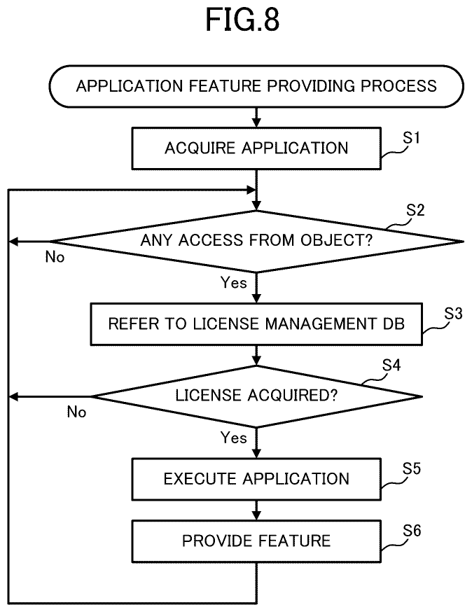

An application feature providing process and a license management process performed in parallel by the license management system 10 are now described with reference to FIGS. 8 to 10.

In the application feature providing process, as illustrated in FIG. 8, the acquirer 61 acquires the application 30 (step S1). The providing section 63 then determines whether any access from an object to use the features of the application 30 has occurred (step S2). When no access from an object is determined (No in step S2), the determination in step S2 is repeated. When access from an object is determined to have occurred (Yes in step S2), the executor 62 searches the license management DB 640 for data about the object that has caused the access (step S3).

Subsequently, the executor 62 determines whether the object identified in the search has a license for the features of the application 30 requested with the access (step S4). When the object is determined not to have acquired the license (No in step S4), the features of the application 30 are not provided to the object, and the processing in step S2 and subsequent steps is repeated. When the object is determined to have acquired the license (Yes in step S4), the executor 62 executes the application 30 for implementing the requested features (step S5), and the providing section 63 provides the features as a response to the access (step S6).

In FIG. 8, the features of the application 30 are provided upon access by an object. However, the features of the application 30 may be provided at any time other than the access by an object. For example, for an application 30 that spontaneously notifies an object of information at a specific time, the features may be provided upon the current time reaching the specific time. Examples of a specific time include a periodic time and time at which an error or an abnormality occurs.

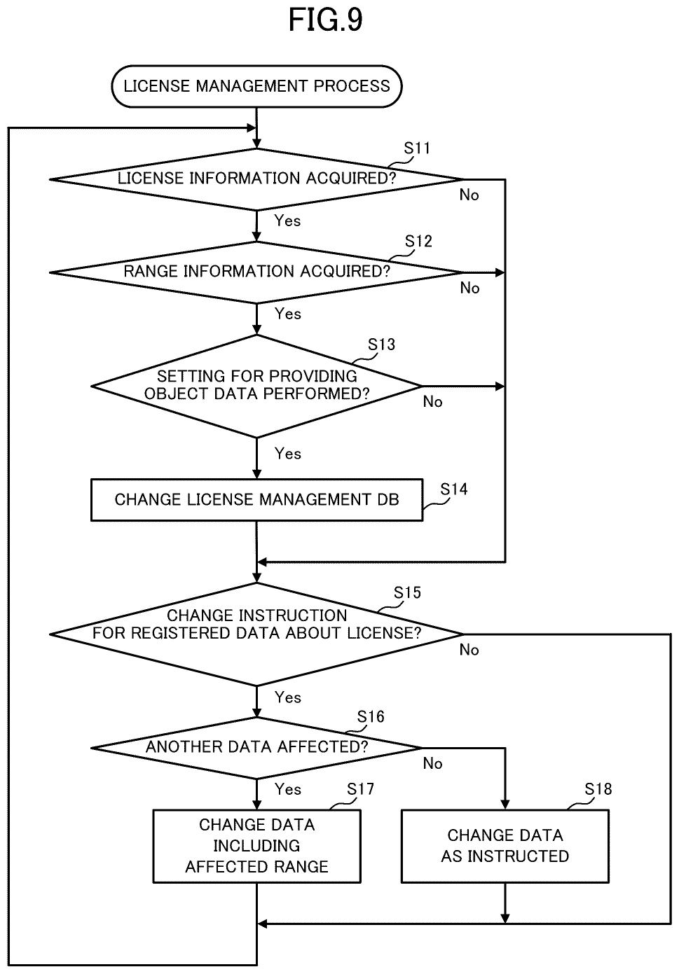

In the license management process illustrated in FIG. 9, the manager 64 determines whether license information indicating granting of a license is acquired (step S11). The license information indicates an object that has newly acquired the license and generation of a new object that has acquired the license. For example, when the object U101 in the example in FIG. 6 grants a license for the application 31 to the object U202, data indicating the object U202 associated with the application 31 corresponds to the license information. When the license information is determined yet to be acquired (No in step S11), the processing in the license management system 10 advances to step S15.

When the license information is determined to have been acquired (Yes in step S11), the manager 64 determines whether range information is acquired (step S12). The range information indicates the range of the features of the application 30 that is available with the newly granted license. When, for example, the object U101 in the example in FIG. 6 grants a license for the application 31 to the object U202, data indicating the license range excluding the third partial feature corresponds to the range information. The license range excluding the third partial feature is indicated by two circles followed by one cross.

When the application 30 has a single feature and the feature cannot be divided or when the provider of the application 30 disables setting the license range between objects, the features available to the object that has acquired the license are equivalent to the features available to the object that grants the license. Thus, the determination in step S12 may be eliminated. When an object simultaneously inputs the license granting target and the license range, the determination in step S11 may be performed as to whether the license information includes the range information, possibly eliminating step S12. However, the license range for each object in each layer is set in advance or as appropriate for each time by the provider of the application 30. When an object grants the license while setting simply the granting target, the manager 64 separately acquires the license information indicating the granting target and the range information indicating the license range.

When the range information is determined yet to be acquired (No in step S12), the processing in the license management system 10 advances to step S15. When the range information is determined to have been acquired (Yes in step S12), the determination is performed as to whether setting for providing the object data is performed (step S13). In the example in FIG. 6, when the object U101 grants the license for the application 31 to the object U202, the determination is performed as to whether the object U202 has permitted the object data to be provided externally.

When the setting for providing the object data is determined yet to be set (No in step S13), the processing in the license management system 10 advances to step S15. When the setting for providing the object data is determined to have been performed (Yes in step S13), the license management DB 640 is changed (step S14). More specifically, the manager 64 records data indicating the settings for the license information, the range information, and the object data into the license management DB 640. The manager 64 corresponds to an example of management means for recording, when acquiring license information indicating generation of the new license acquiring object, data indicating the new license acquiring object to manage a database including a plurality of the license acquiring objects including a license granting object being the license acquiring object that has granted the license and the new license acquiring object.

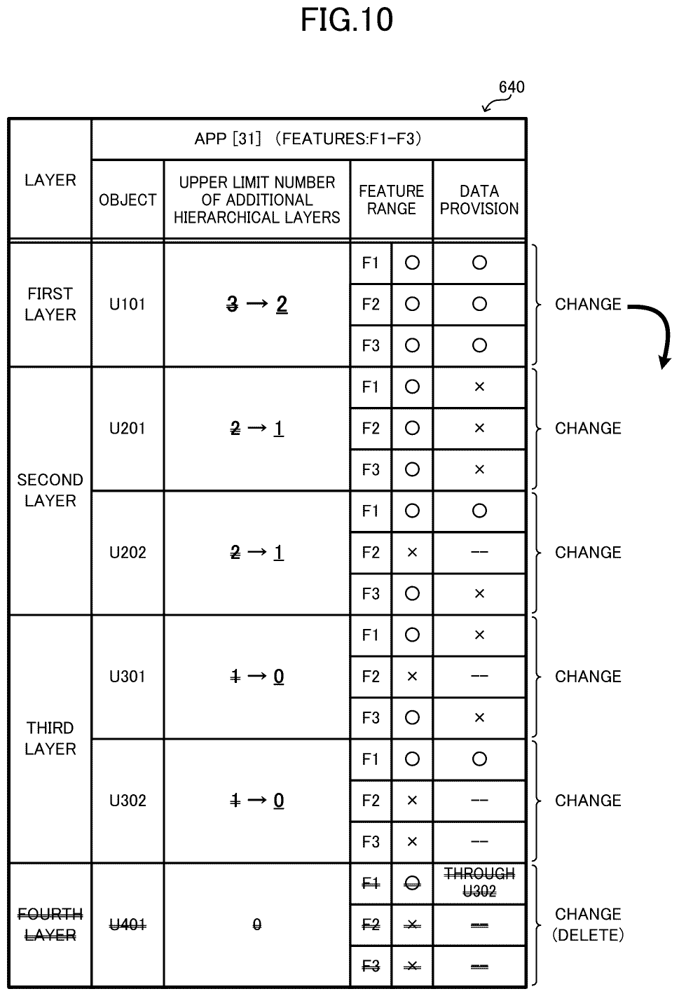

The manager 64 then determines whether there is a change instruction for changing the registered data about the license in the license management DB 640 (step S15). The change instruction is, for example, an instruction to change the upper limit number of additional hierarchical layers for the object U101 from 3 to 2, as illustrated in FIG. 10.

When determining that there is not the change instruction (No in step S15), the license management system 10 repeats the processing in step S11 and subsequent steps. When determining that there is the change instruction (Yes in step S15), the manager 64 determines whether the change instruction affects other data (step S16). In the example in FIG. 10, the change in the upper limit number of additional hierarchical layers in the first layer affects the upper limit numbers of additional hierarchical layers in the second layer and subsequent layers, and thus the data in the second layer and the subsequent layers is also to be changed.

When determining that the change instruction affects other data (Yes in step S16), the manager 64 changes data including the affected range based on the change instruction (step S17). In the example in FIG. 10, the upper limit number of additional hierarchical layers is changed in the second layer and the third layer. In the fourth layer, the upper limit number of additional hierarchical layers is changed to a negative value that is not permitted. Thus, the entire data about the fourth layer is deleted. The manager 64 then repeats the processing in step S11 and subsequent steps.

When determining that the change instruction does not affect other data (No in step S16), the manager 64 changes data based on the change instruction (step S18). When, for example, the license range is changed or the setting about providing object data is changed, the manager 64 changes the license management DB 640 based on the change instruction. The manager 64 then repeats the processing in step S11 and subsequent steps.

As described above, the manager 64 in the present embodiment records, when acquiring license information indicating generation of a new license acquiring object resulting from granting of a license from a license acquiring object, data indicating the new license acquiring object into the license management DB 640. Thus, the features of the application software can be provided based on a sublicense concluded between objects. This facilitates the use of the cloud service based on a license reflecting the connections at FA sites, promoting the use of the cloud service by reducing the workload for using the cloud service at the FA sites.

The manager 64 acquires the license information and the range information indicating a license range of the new license acquiring object with a range equivalent to the license range of the license granting object or within the license range and manages the license management DB 640 indicating multiple objects each associated with the license range. This allows the features sufficiently satisfying the requests from individual objects to be provided.

The collector 65 collects object data from each object. This allows analysis of data across connections at FA sites where the application is used.

The collector 65 collects object data about an object through a license granting object that has granted the license to the object. This allows the object data to be collected through various collection paths. Object data about an object may be collected through a license acquiring object that has acquired the license granted from the object.

When an object has a setting of not providing the object data, the collector 65 excludes the object data from the collection targets. Thus, data unintended to be externally provided can be concealed.

When acquiring the license information, the manager 64 records the data indicating a new license acquiring object in a layer lower than a layer of the license granting object to manage the license management DB 640 indicating multiple objects in a hierarchical manner. This allows license management based on the depth of the hierarchical layer as illustrated in FIG. 10.

More specifically, a new license acquiring object is permitted to repeatedly grant the license as a license granting object. When the upper limit number of additional hierarchical layers indicating the number of times the new license acquiring object is permitted to repeatedly grant the license is decreased, the manager 64 deletes, from the license management DB 640, data about an object in a layer lower than the layer corresponding to the upper limit number of additional hierarchical layers. Thus, the provider of the application 30 can control the upper limit of license hierarchical layers.

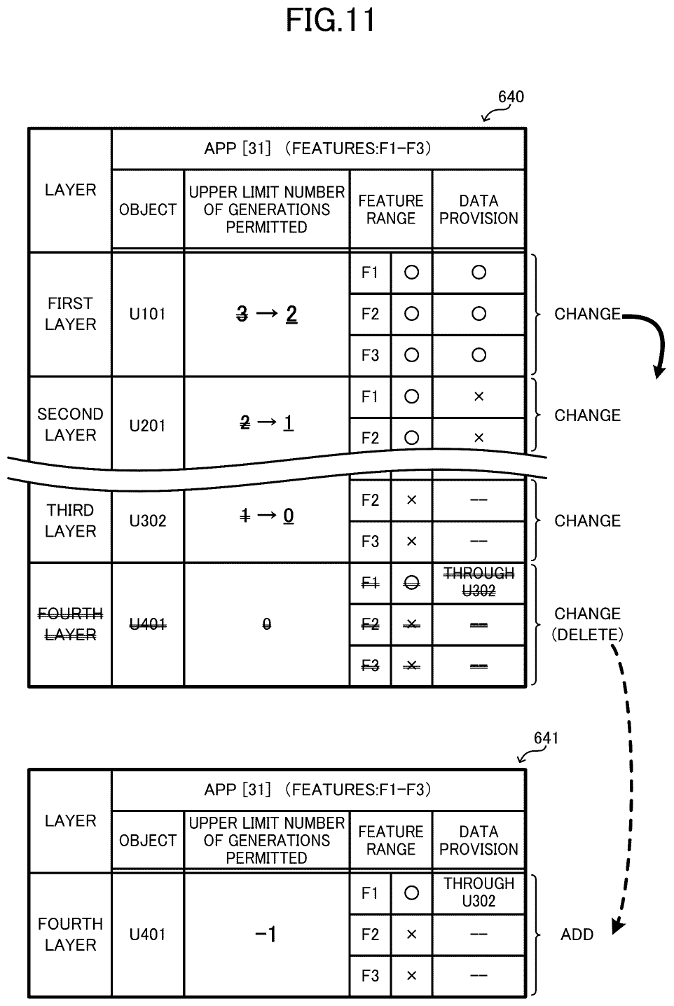

Although the upper limit number of additional hierarchical layers is decreased in the above example, the upper limit number of additional hierarchical layers may be increased. As illustrated in FIG. 11, the manager 64 may transfer and store the data in the fourth layer deleted from the license management DB 640 into a temporary DB 641. When the upper limit number of additional hierarchical layers is increased, the manager 64 may restore the data in the fourth layer into the license management DB 640.

The manager 64 may manage a license management DB 640 without the item of Layer. More specifically, the manager 64 may manage the license of each object independently of the actual depth of the hierarchical layer.

### Embodiment 2

Embodiment 2 is described focusing on the differences from Embodiment 1 described above. Like reference signs denote like or corresponding components in Embodiment 1. The license management DB 640 in Embodiment 1 indicating hierarchical layers of the objects does not indicate the target for granting the license from each object. The present embodiment differs from Embodiment 1 in that the license management DB 640 indicates the license granting relationships.

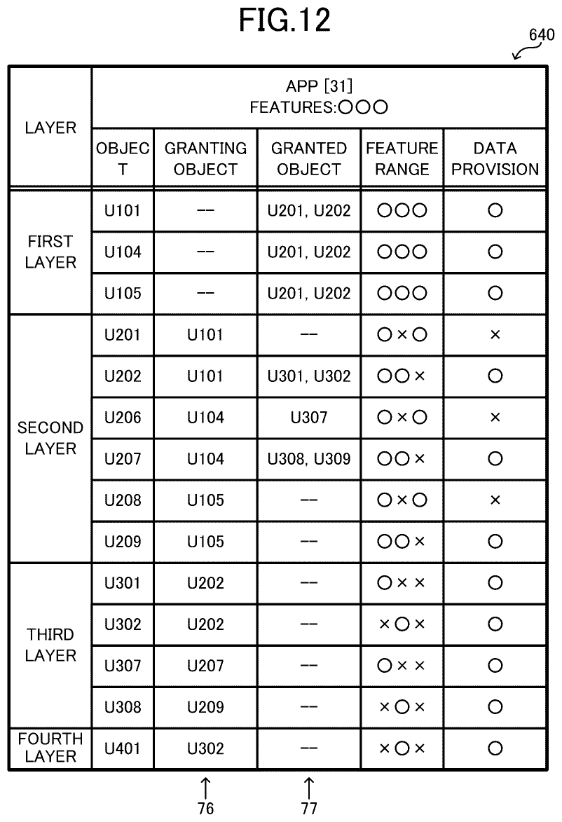

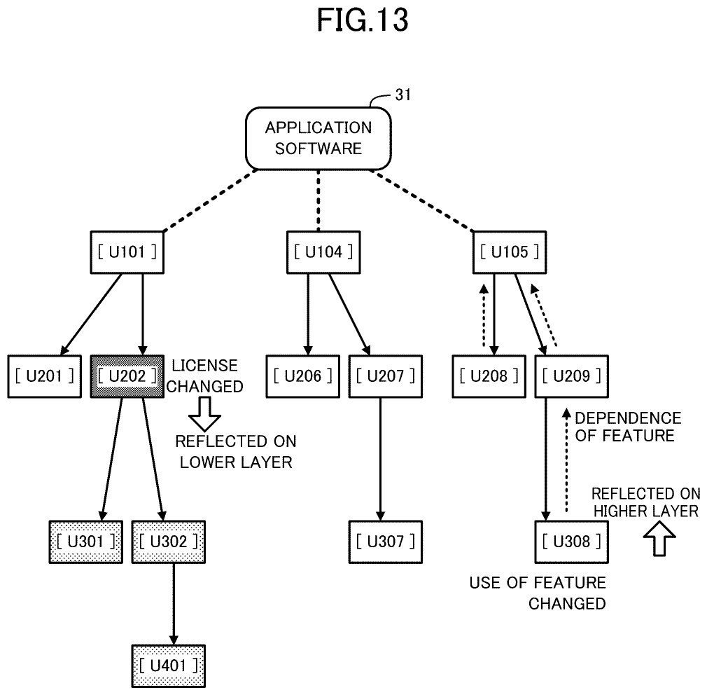

The license management DB 640 in the present embodiment includes, as illustrated in FIG. 12, a column 76 of Granting object and a column 77 of Granted object. The column 76 of Granting object indicates license granting objects that have each granted a license to the corresponding object. The column 77 of Granted object indicates license acquiring objects to each of which a license is granted from the corresponding object. Thus, the license management DB 64 substantially has a tree structure illustrated in FIG. 13. When acquiring the license information, the manager 64 records data indicating granting of a license from a license granting object to a new license acquiring object to manage a database indicating the license granting relationship among multiple license acquiring objects.

Thus, a change in the license of any object can be reflected on the license of a lower layer object that is dependent on that license. Examples of a change in a license include disabling the license, changing the license range, and changing the license period. For example, as illustrated in FIG. 13, when the license of the darkly hatched object U202 is disabled, the license of the objects U301 and U302 to which the license is granted from the object U202 and the license of the object U401 to which the license is further granted from the object U302 can be disabled.

The manager 64 thus changes, when the license acquired by a specific object is changed, data about the license granted directly or indirectly from the specific object to another object. This allows flexibly managing the license management DB 640 based on the license granting relationship.

The provided features may have dependence in a direction opposite to the granting of the license. More specifically, the object data resulting from providing of features to an object in a lower layer may be used by the features provided to an object in a higher layer. For example, in the tree structure in FIG. 13, a host computer may detect an abnormality based on the sensing results acquired by a device in a lower layer. In another example, an update schedule of a device of a device manufacturer or a service life of a tool in a higher layer may be estimated based on the operation schedule of a production line of an end object in a lower layer.

In such cases, the providing section 63 can refer to the license management DB 640 to determine the features to be provided to a specific object based on the features provided to the license acquiring object to which the license is granted directly or indirectly from the specific object. This allows various features to be provided to the object.

Although the embodiments of the present disclosure are described above, the present disclosure is not limited to the above embodiments.

For example, the number of applications 30, the number of objects, and the number of hierarchical layers are not limited to the above examples and may be changed as appropriate.

Although the license management table 640 is in the form of a table in the examples described above, the license management table 640 may be in any other form.

The functions of the license management system 10 according to the above embodiments can be implemented by dedicated hardware or a general computer system.

For example, the programs P1 and P2 may be stored in a non-transitory computer-readable recording medium, such as a flexible disc, a compact disc read-only memory (CD-ROM), a digital versatile disc (DVD), or a magneto-optical (MO) disk, and may be distributed. The programs P1 and P2 can be installed in a computer to provide a device that performs the above processing.

The programs P1 and P2 may be stored in a disk device included in a server on a communication network, such as the Internet, and may be, for example, superimposed on a carrier wave to be downloaded to a computer.

The above processing may also be performed by the programs P1 and P2 activated and executed while being transferred through a network, such as the Internet.

The above processing may be performed by entirely or partially executing the programs P1 and P2 on a server while a computer is transmitting and receiving information about the processing through a communication network.

In the system with the above functions implementable partially by an operating system (OS) or through cooperation between the OS and applications, portions executable by the applications other than the OS may be stored in a non-transitory recording medium that may be distributed or may be downloaded to a computer.

Means for implementing the functions of the license management system 10 is not limited to software, and may be partially or entirely implemented by dedicated hardware or a dedicated circuit.

The foregoing describes some example embodiments for explanatory purposes. Although the foregoing discussion has presented specific embodiments, persons skilled in the art will recognize that changes may be made in form and detail without departing from the broader spirit and scope of the invention. Accordingly, the specification and drawings are to be regarded in an illustrative rather than a restrictive sense. This detailed description, therefore, is not to be taken in a limiting sense, and the scope of the invention is defined only by the included claims, along with the full range of equivalents to which such claims are entitled.

### INDUSTRIAL APPLICABILITY

The technique according to one or more embodiments of the present disclosure is suitable for managing a license to receive a cloud service.

### REFERENCE SIGNS LIST

10 License management system
20 to 22 Application provider
30 to 33 Application
40 Cloud server
41 Cloud infrastructure
51 Processor
52 Main storage
53 Auxiliary storage
54 Input device
55 Output device
56 Communicator
57 Internal bus
61 Acquirer
62 Executor
63 Providing section
64 Manager
640 License management DB
641 Temporary DB
65 Collector
650 Object data DB
66 Output device
71 to 73 Row data
74, 76, 77 Column
D11, D12 Data
NW Network
P1, P2 Program
U1, U101 to U103, U111 to U114, U2, U201 to U205, U211 to U214, U3, U301 to U306, U311 to U314 Object

1. A license management system, comprising:
processing circuitry to
acquire application software;
execute the application software;
provide, through a network, a feature implemented by execution of the application software to a license acquiring object that has acquired a license;
manage, in a manner associated with the application software being a target for the license, a new license acquiring object generated upon granting of the license from the license acquiring object with a range equivalent to a license range of the feature for which the license acquiring object has acquired the license or within the license range; and
collect object data from the license acquiring object, the object data being at least one of data for the license acquiring object to use the feature or data generated by use of the feature by the license acquiring object.

2. The license management system according to claim 1, wherein
the processing circuitry records, when acquiring license information indicating generation of the new license acquiring object, data indicating the new license acquiring object to manage a database indicating a plurality of the license acquiring objects including a license granting object being the license acquiring object that has granted the license and the new license acquiring object.

3. The license management system according to claim 2, wherein
the processing circuitry provides the feature of the application software to the license acquiring object with the license range for which the license acquiring object has acquired the license, and
the processing circuitry acquires range information indicating the license range for the new license acquiring object and the license information to manage the database indicating the plurality of license acquiring objects each associated with a corresponding license range.

4. (canceled)

5. The license management system according to claim 1, wherein
the processing circuitry collects the object data about the license acquiring object through another license acquiring object granting the license to the license acquiring object or through another license acquiring object to which the license is granted from the license acquiring object.

6. The license management system according to claim 1, wherein
when the license acquiring object has a setting of not providing the object data, the processing circuitry excludes the object data from collection targets.

7. The license management system according to claim 2, wherein
the processing circuitry records, when acquiring the license information, data indicating the new license acquiring object in a layer lower than a layer in which the license granting object is included to manage the database indicating the plurality of license acquiring objects in a hierarchical manner.

8. The license management system according to claim 7, wherein
when an upper limit of the number of sequential license granting in which a new license acquiring object grants the license as a license granting object decreases, the processing circuitry deletes, from the database, data indicating the license acquiring object in a layer lower than a layer corresponding to the upper limit of the number.

9. The license management system according to claim 2, wherein
the processing circuitry records, when acquiring the license information, data indicating granting of the license from the license granting object to the new license acquiring object to manage the database indicating a granting relationship of the license among the plurality of license acquiring objects.

10. The license management system according to claim 9, wherein
when the license acquired by a specific license granting object is changed, the processing circuitry changes data about the license granted directly or indirectly from the specific license granting object to the license acquiring object.

11. The license management system according to claim 9, wherein
the processing circuitry refers to the database to determine, based on the feature provided to the license acquiring object to which the license is granted directly or indirectly from a specific license granting object, the feature to be provided to the specific license granting object.

12. A license management method, comprising:
executing, with an executer, application software;
providing, with a provider, through a network, a feature implemented by execution of the application software to a license acquiring object that has acquired a license; and
managing, with a manager, in a manner associated with the application software being a target for the license, a new license acquiring object generated upon granting of the license from the license acquiring object with a range equivalent to a license range of the feature for which the license acquiring object has acquired the license or within the license range
collecting, with a collector, object data from the license acquiring object, the object data being at least one of data for the license acquiring object to use the feature or data generated by use of the feature by the license acquiring object.

13. A non-transitory computer-readable recording medium storing a program, the program causing a computer connected to a network to function as:
an acquirer to acquire application software;
an executer to execute the application software;
a provider to provide, through a network, a feature implemented by execution of the application software to a license acquiring object that has acquired a license;
a manager to manage, in a manner associated with the application software being a target for the license, a new license acquiring object generated upon granting of the license from the license acquiring object with a range equivalent to a license range of the feature for which the license acquiring object has acquired the license or within the license range; and
a collector to collect object data from the license acquiring object, the object data being at least one of data for the license acquiring object to use the feature or data generated by use of the feature by the license acquiring object.

14. The license management system according to claim 7, wherein
the processing circuitry records, when acquiring the license information, data indicating granting of the license from the license granting object to the new license acquiring object to manage the database indicating a granting relationship of the license among layers in which the plurality of license acquiring objects are included.
